(19) United States
(12) Patent Application Publication
(10) Pub. No.: US 2019/0344696 A1
(43) Pub. Date: Nov. 14, 2019

(54) Mobile Workstation

(71) Applicant: Troy Pritchard, Coral Springs, FL (US)

(72) Inventor: Troy Pritchard, Coral Springs, FL (US)

(21) Appl. No.: 15/976,764

(22) Filed: May 10, 2018

(51) Int. Cl. B60N 3/00; A47B 21/03

(52) U.S. Cl. CPC B60N 3/001; A47B 21/0314

(57) ABSTRACT

A mobile workstation for the backseat of a motor vehicle. The workstation having first and second sections. A user can place a laptop computer on the first section. The second surface provides addition area for office supplies, computer peripherals or paperwork.

This application is the Non-Provisional application for the Mobile Workstation with patent Application No. 62/602,862, filed on May 10, 2017 as Provisional Application. Applicant: Troy Pritchard, U.S citizen, from Coral Springs, Fla., USA.

### BACKGROUND OF THE INVENTION

The presently claimed invention is a mobile workstation for use in a motor vehicle. The workstation allows a user to perform tasks typically conducted in an office setting. The workstation is lightweight, attaching securely to the interior of the vehicle. The workstation can be easily removed when not needed. Only minor alteration to the vehicle must be done to accommodate installation of the workstation. When one removes the workstation, the vehicle can be used for non-business activities.

Desks in motor vehicles are known in the prior art. U.S. Pat. No. 4,792,183 to Townsend, III discloses a Desk for Use in Automobiles. Townsend's desk is intended for backseat occupants and is mounted to the seat in front of the backseat.

U.S. Pat. No. 4,829,910 to Lirette discloses a Folding Table for a Recreational Vehicle. Lirette's table folds into a hollow space, so as to be unobtrusive when not in use.

U.S. Pat. No. 5,359,349 to Jambor et al. discloses a Video Display Unit (VDU) Workstation. Jambor's workstation is for mounting to the back of a front seat, for use by a backseat occupant. The workstation folds out of the way, when not in use.

U.S. Pat. No. 8,109,565 to Waters et al. discloses a Automotive Seat Reconfigurable to Work Desk. Water's desk is for use by a front seat occupant, who sits in the driver's seat. The desk rests over the front passenger seat.

The mobile workstation addresses the problems of performing tasks in the field by professionals such as insurance adjusters, real estate professionals, or appraisers. The mobile workstation benefits anyone who has to go to clients or customers to provide and prepare reports. The user benefits from the ability to gather data, analyze that data, and deliver documents or reports in a timely manner.

### BRIEF DESCRIPTION OF THE DRAWINGS

FIG. 1 is a perspective view of the large and small desk joined together, small desk at home position in relation to pillar.

FIG. 2 is an exploded perspective showing section line for FIG. 4.

FIG. 3 is an underside view of the two piece desk.

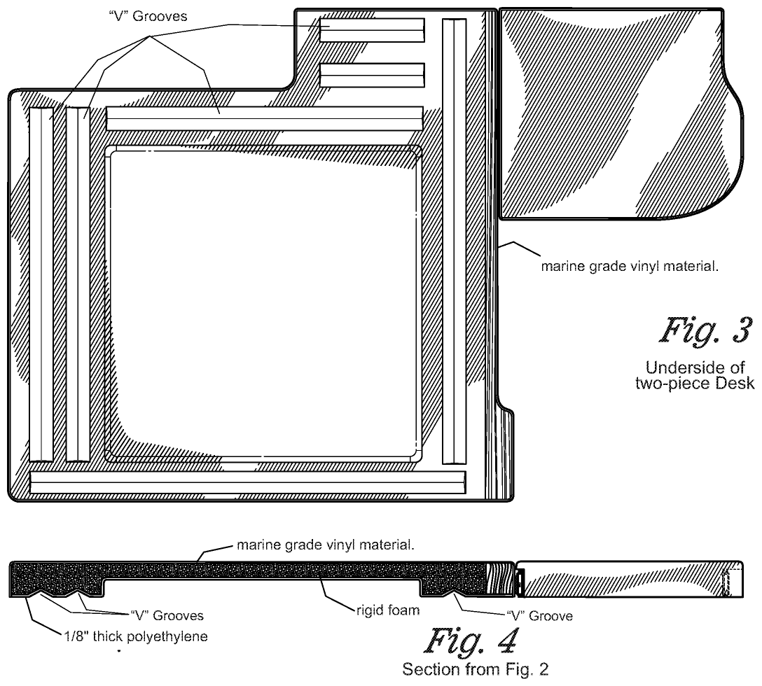

FIG. 4 is a sectional view from FIG. 2

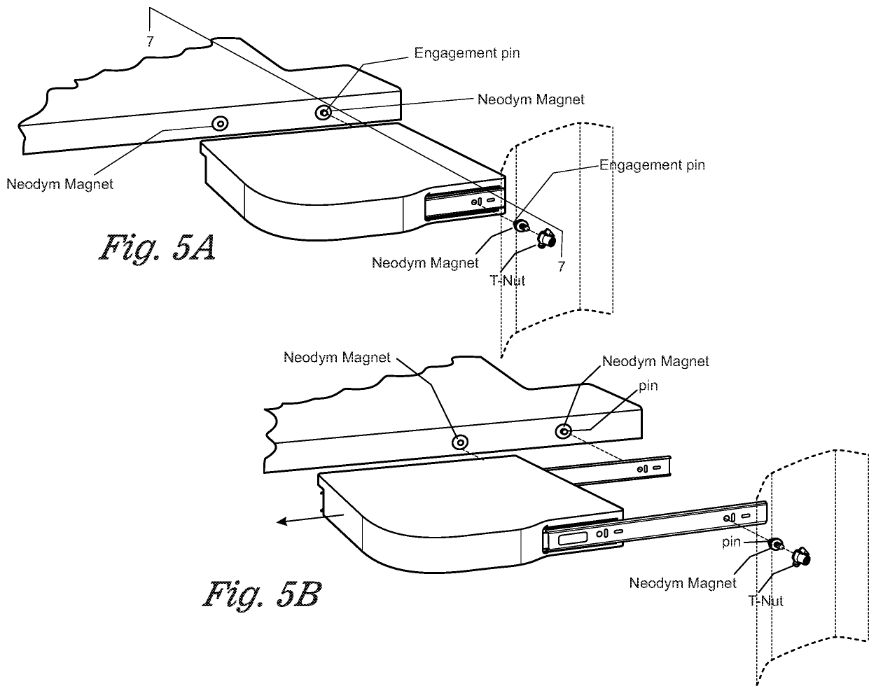

FIG. 5A is a view showing the positioning of the desk with Neodym magnet

FIG. 5B is a view showing the desk moved back.

FIG. 6 is an underside view illustrating the interaction of drawer slides with mounts on right side of large desk.

FIG. 7 is a sectional view of FIG. 2.

FIG. 8 is a second sectional view of FIG. 2.

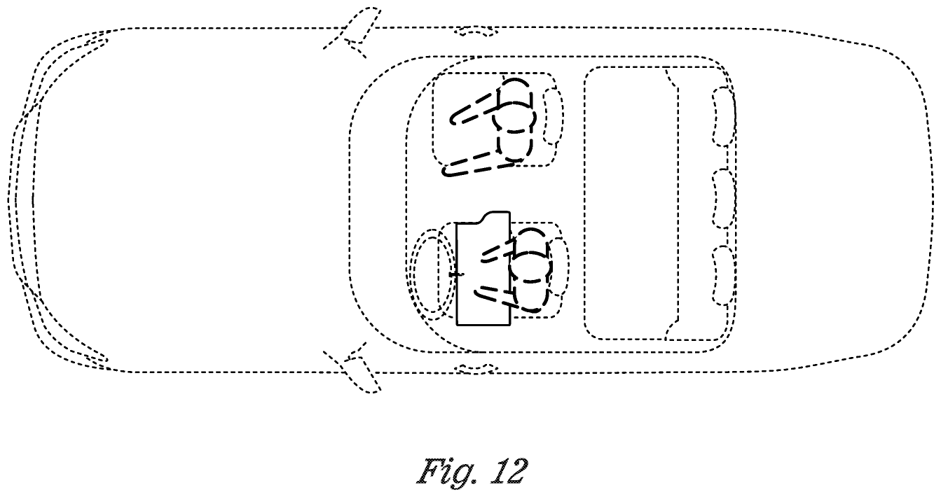

FIG. 9 is a view from above the vehicle, illustrating the location of the desk within the vehicle.

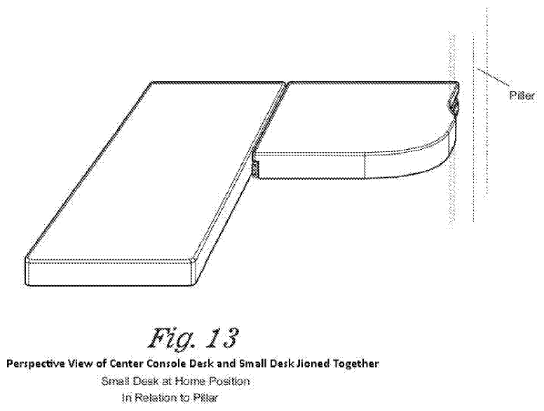

The mobile workstation is typically installed in the portion of the vehicle behind the driver and the front seat passenger. In trucks, vans or SUV's, the backseat of a vehicle tends to have more space. These vehicles are also larger than the typical automobile. Hence a professional on the go would be more likely to use them.

The workstation has surfaces for supporting a computer, and computer peripherals, such as printers, scanners, and copiers. Storage space for office supplies is integrated into the workstation.

Additionally, the workstation is threaded with wires and cables to neatly organize the power and communication needs of the user and information processing equipment.

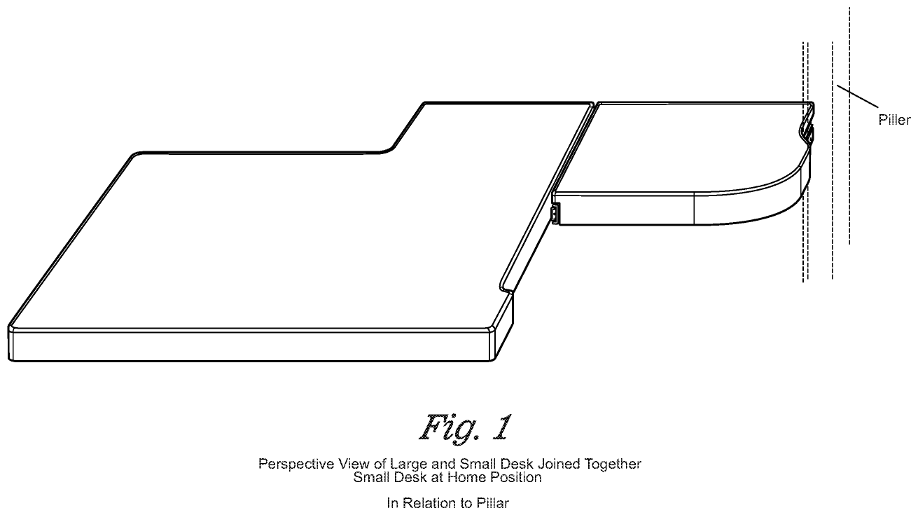

A first embodiment of the invention provides for a workstation with four sections. See generally, FIG. 1, which generally illustrates the elements.

A first section, or deskwork surface, has a user work surface that typically accommodates a lap top computer or provides a surface on which a user might read or write. This surface is positioned behind the front passenger seat. When using the workstation the user can move the front passenger seat forward allowing more room. The user in turn sits in a seat behind the front passenger seat.

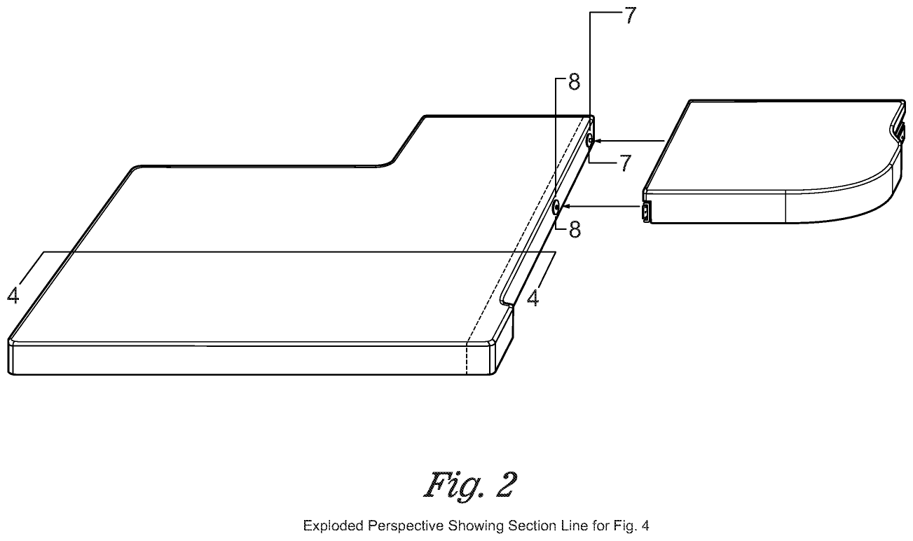

A second section, a work surface console, provides more surface area for the user. The work surface console also has integrated storage tray, for office supplies, and even a cup holder. The work surface console has a laptop storage slot, as shown in FIG. 2, for storing a laptop computer out of sight, so as to not tempt thieves.

A third surface, or accessory surface, is positioned behind the driver seat. This section is for computer accessories such as a printer or scanner. A client can sit in the seat directly behind the third surface.

A fourth surface, or auxiliary surface, can be installed behind to the accessory surface and next to the work surface console. It provides additional surface area when needed.

At least two magnetized mounting pins are positioned on a first edge of the console work surface. This is generally illustrated in FIG. 2. A support slide on the edge of the deskwork surface has at least two holes for receiving the magnetized mounting pins. The support slide allows temporary mounting of the first surface to the console.

To install, the user extend the slide and inserts the mounting pins into the holes. The user then slides the first surface toward the front of the vehicle. The door facing edge of the first surface contacts the door jam of the vehicle, thereby holding the first surface firmly in place.

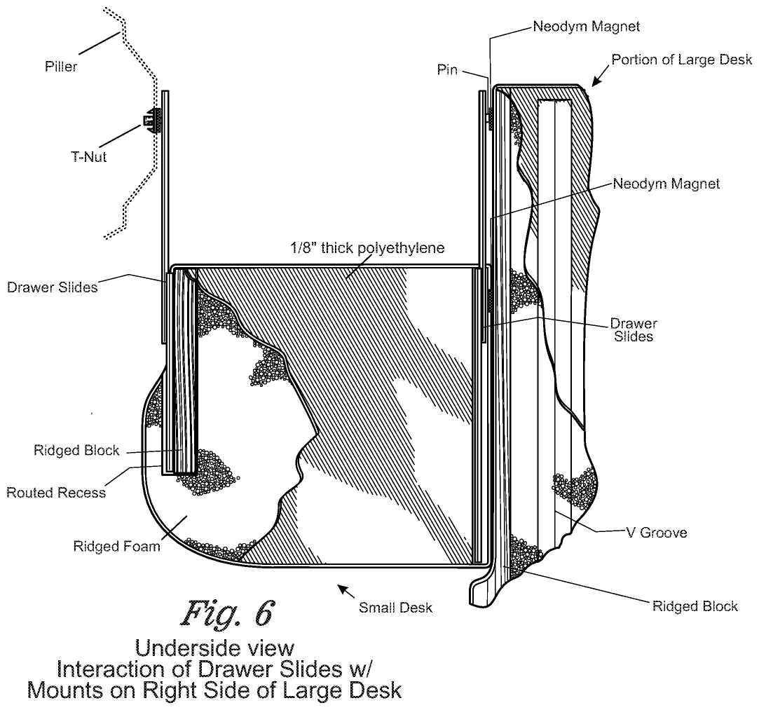

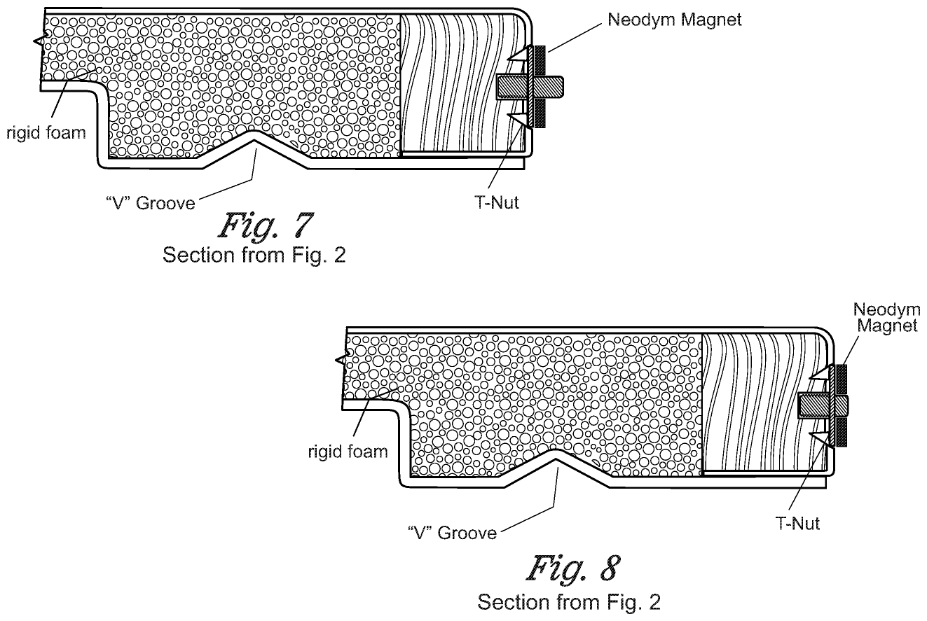

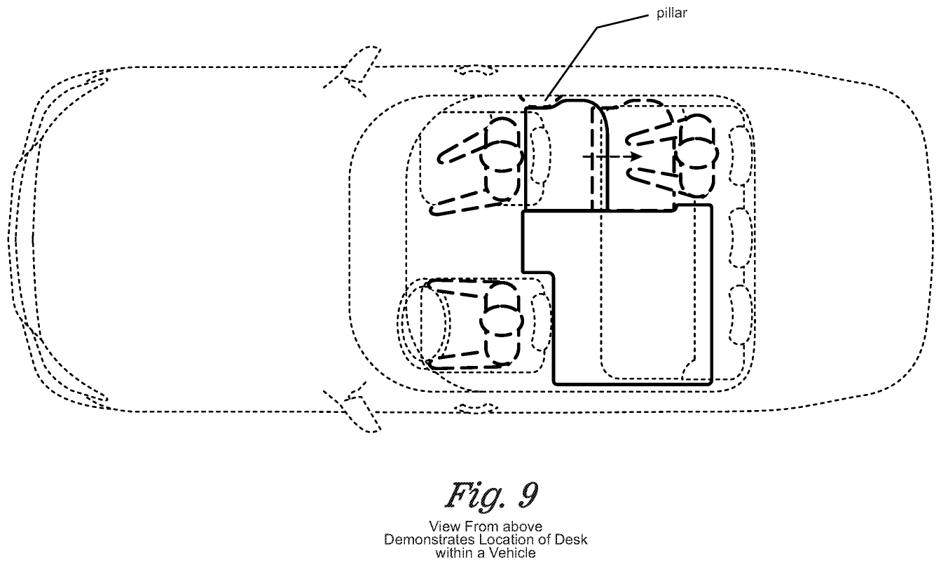

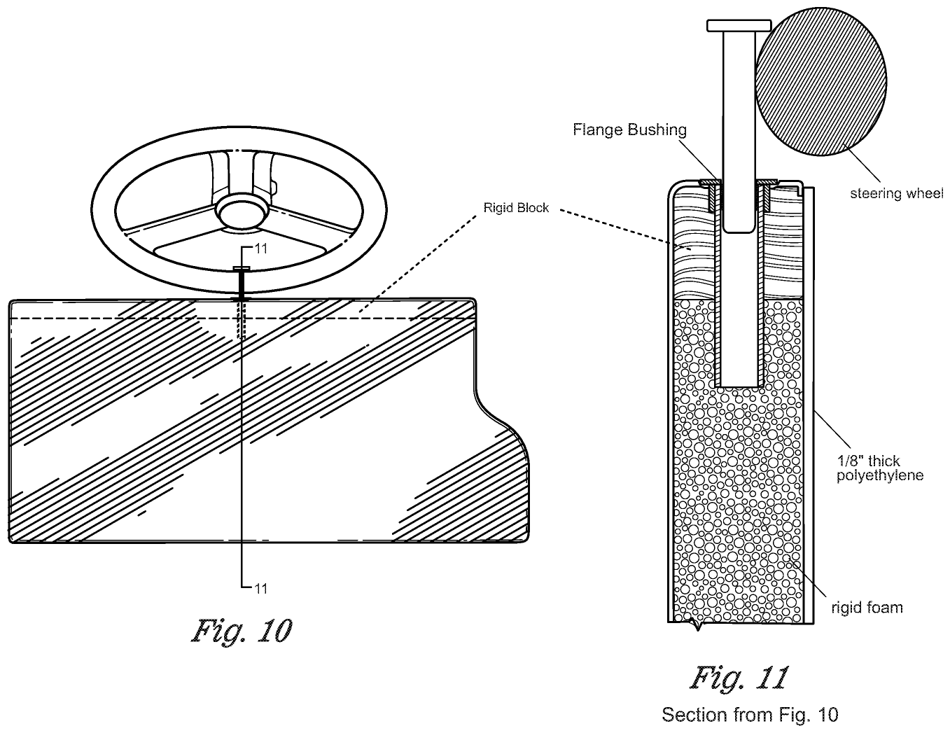

A second embodiment contemplates the use of two primary surfaces, with the option of a third surface. See generally, FIGS. 5-7.

I claim:

1. A mobile workstation, comprising:
a first section, having a work surface, a first section underside surface, a door mounting edge, a user facing edge, a slide edge and a first section front seat edge;
a second section, having a console work surface, a second section underside surface, a second section sliding edge, a second section front seat edge, a second section backseat edge, and a distal edge, wherein the second section sliding edge connects to the first section.

2. The mobile workstation of claim 1, further comprising:
a third section, having an attachment edge, wherein the attachment edge connects to the distal edge of the second section.

3. The mobile workstation of claim 1, further comprising:
at least two mounting pins positioned on the sliding edge of the second section, and a support slide on the slide edge of the first section, wherein the mounting pins attach to the support slide.
